(19) United States
(12) Patent Application Publication
(10) Pub. No.: US 2006/0114683 A1
(43) Pub. Date: Jun. 1, 2006

(54) Illumination unit for aircraft

(75) Inventors: Detlef Heym, Achim (DE); Carsten Kohlmeier-Beckmann, Buxtehude (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Airbus Deutschland GmbH, Hamburg (DE)

(21) Appl. No.: 11/252,447

(22) Filed: Oct. 18, 2005

Related U.S. Application Data
(60) Provisional application No. 60/620,376, filed on Oct. 20, 2004.

(30) Foreign Application Priority Data
Oct. 20, 2004 (DE) 10 2004 051 146.2

(51) Int. Cl. F21V 11/00

(52) U.S. Cl. 362/471; 362/351

(57) ABSTRACT

In present-day passenger aircraft, fluorescent lamps in tubular form, are used as general illumination. An illumination unit for aircraft having a two-dimensional light source, an aperture which is at least partly translucent, and an attachment element. In this arrangement, the aperture is an interior fitting element of an aircraft cabin so that the entire illumination unit can be integrated in the aircraft cabin when the interior fitting element is installed. The flat design of the light source makes the installation of the light source possible in spaces of limited depth.

### RELATED APPLICATIONS

This application claims the benefit of the filing date of U.S. Provisional Patent Application No. 60/620,376 filed Oct. 20, 2004, the disclosure of which is hereby incorporated herein by reference, and claims the benefit of the filing date of German Patent Application 10 2004 051 146.2, filed Oct. 20, 2004.

### FIELD OF THE INVENTION

The field relates to illumination systems for aircraft. In particular, the field relates to an illumination unit for an aircraft; and an aircraft comprising a corresponding illumination unit.

### TECHNOLOGICAL BACKGROUND

In present-day passenger aircraft, fluorescent lamps in tubes are often used as general illumination. Furthermore, to display certain information in present-day passenger aircraft, so-called signs which display the information as text or as pictograms are used. For example, signs or illuminated panels for displaying instructions or warning notes such as for example “No smoking” or “Fasten seat belt,” are displayed. All these illumination devices are associated with the disadvantage in that they require a relatively deep installation depth. Consequently, it is not possible to install them on just any desired surface because there is often not enough space behind such a surface for a corresponding installation. Furthermore, due to the often covered installation a large part of light energy is reflected backwards or sideways, and hence only a small fraction of light energy provided is actually usable.

### SUMMARY OF THE INVENTION

According to one embodiment of the present invention, an illumination unit for aircraft comprises a two-dimensional light source, an aperture (or a screen) which is at least partly translucent, and an attachment element, wherein the light source is connected to the aperture by way of the attachment element, and wherein the light source is arranged behind the aperture and at least partly shines through the aperture.

By means of the illumination unit of one embodiment of the invention, the illumination unit may be installed in locations, which are so limited in depth, that the locations provide insufficient room for known fluorescent lamps. Due advantage is that the aperture may partly shield the light source, displaying information that is viewable by passengers. The flat-shaped design of the illumination may generate large illumination surfaces or information surfaces which, in one example, are integrated in a sidewall of the aircraft cabin.

The aperture, which is at least partly translucent, may be an interior fitting element of an aircraft cabin such as wall panelling, window panels, side panels, ceiling panelling and baggage lockers, for example.

One advantage of using an interior fitting element as an aperture is a reduction of costs associated with installation of the illumination unit in the aircraft. Another advantage is that using the interior fitting element eliminates structure for use as an aperture saving space and material.

According to one embodiment, the light source is a discharge lamp that is free of any mercury. An illumination unit may feature high light density, good light density homogeneity, good color quality, a long service life and good environmental compatibility.

According to one embodiment, the light source comprises an attachment region using an attachment element, such as a screw, a rivet, self-locking plug-in bolt or clip. The attachment region may be opened for attaching the light source to the aperture, which simplifies installation and replacement of a light source.

According to a further embodiment, the aperture is at least partly translucent and comprises a recess. The recess is at least partly filled with a transparent material that is durable. Thus, a light source is protected by the aperture against mechanical damage or soiling. The transparent material for covering the light source may be of any shape such as a shape usable for display of information.

The transparent material may be any transparent material, such as plastic, plexiglass and glass. These are robust materials that are easy to process and may comprise a high degree of functionality. By combining transparent and non-transparent materials innovative design elements and information elements may be created in the cabin.

An aperture may have a protective mesh or a protective cover to protect the two-dimensional light source against mechanical damage. The protective mesh or the protective cover may be designed to protect of the light source of an illumination unit in a freight space of an aircraft, for example.

According to one embodiment, the recess of the aperture is designed to accommodate a diffuser, a radiation filter or projection optics, wherein said projection optics comprise at least one lens. This may be possible to provide diffuse or filtered light for illuminating the cabin, or to project the light rays in a targeted manner onto a corresponding projection surface. For example, an indirect information display system in the form of the illumination unit can be provided, wherein information can be projected onto a projection surface.

According to one embodiment, the recess of the aperture is designed to accommodate a liquid crystal display. In this way, it may be possible to display changing information using the illumination unit. An illumination unit may include a data port for externally controlling a liquid crystal display, which may display data transmitted via the data port.

The liquid crystal display may be operated from an external controller desk, for example. It may be possible to externally issue corresponding control commands to the liquid crystal display and the entire illumination unit. Such control commands, subsequently may result in a corresponding information display. This leads to a flexibility of displaying illumination colors or information, such as static information, dynamic information, seat-row information, seat place information, warning information, prohibition information, flight information, escape route information and entertainment information. For example, a sunrise, a starry night sky, an airline logo or advertising may be displayed statically or dynamically. For example, an illumination unit displaying dynamic information may provide at a given point in time information concerning a corresponding seat row in front of the passenger, or information concerning a particular seat which the passenger is looking for; and at another point in time, warning information, for example, in the form of a “fasten seatbelt” signal. In an emergency, the same display may provide the way to the nearest emergency exit. Additionally, it is also possible for the illumination unit to display visual information to entertain passengers, for example, films or simply relaxing patterns, shapes or figures in various colors and movement sequences.

In one example, an extremely flexible, individually programmable, controllable illumination system is adaptable to changing requirements and situations.

### BRIEF DESCRIPTION OF THE DRAWINGS

In the drawings the same reference characters are used for identical or similar elements. Below, examples are described with reference to the drawings.

FIG. 1 shows a diagrammatic representation of an illumination unit.

FIG. 2 shows a diagrammatic representation of an illumination unit.

FIG. 3 shows a diagrammatic representation of an illumination unit comprising a liquid crystal display and a data port.

FIG. 4 shows a diagrammatic representation of an illumination unit with projection lenses.

FIG. 5 shows a diagrammatic representation of an illumination unit with a metal-coated aperture.

FIG. 6 shows a diagrammatic representation of an illumination unit.

FIG. 7 shows a diagrammatic cross-sectional representation of a first section of an illumination unit comprising a protective mesh.

FIG. 8 show a diagrammatic cross-sectional representation of a second region of the illumination unit of FIG. 7.

### DETAILED DESCRIPTION OF PREFERRED EMBODIMENTS

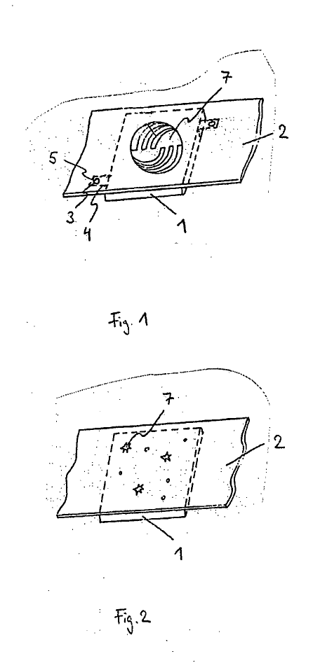

FIG. 1 shows a diagrammatic representation of an illumination unit according to one embodiment of the present invention. As shown in FIG. 1, the illumination unit comprises a two-dimensional light source 1, an aperture 2, which is at least partly translucent, and an attachment element 3. The two-dimensional light source 1 is firmly connected to the aperture 2 by way of the attachment element 3. An attachment region 4 which comprises a recess 5. As shown in FIG. 1, the attachment region 4 is an angle-shaped arrangement which is firmly connected to the two-dimensional light source 1. The attachment element 3, for example, is a screw, rivet or a self-locking plug-in bolt. It is also possible for the light source 1 to be clipped to the aperture 2 by means of a clip.

The aperture 2 is an interior fitting element of an aircraft cabin, wherein interior fitting element is a wall paneling, a ceiling element or a baggage locker. The two-dimensional light source 1 can be made in the form of a discharge lamp that does not contain any mercury. The discharge lamp may additionally feature high light density, good light density homogeneity, good colour quality and a long service life. The hues or shades that are radiated from the light source 1, for example, correspond to those of the general lighting. For example, the entire light source 1 may be exchangeable as a unit, may have a radiator characteristic that conforms to Lambert's law, and may be free of any mercury. An advantage of such an example is above-average environmental compatibility.

Furthermore, the aperture 2, which is partly translucent, comprises a recess 7 through which light from the light source 1 shines. By shaping the recess 7, shapes, patterns, icons or text may be displayed by means of illumination.

Th example shown in FIG. 2 illustrate recesses 7 that are designed in the form of star-shaped cut-outs so that the combination of the light source 1 and the aperture 2 creates the impression of a star-studded sky such that the corresponding illumination intensity and illumination color can have an agreeable, calming effect on passengers.

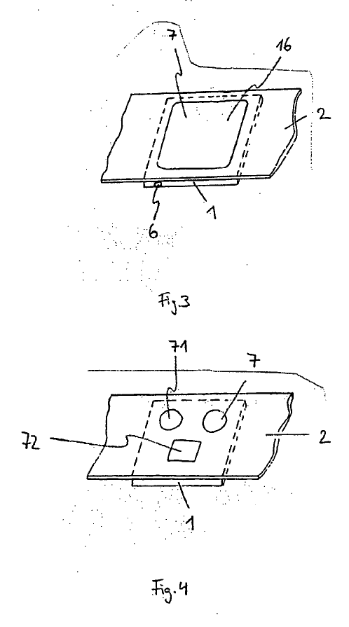

In FIG. 3 a liquid crystal display 16 has been integrated in the recess 7 of the aperture 2, through which display the light source 1 shines. By way of the data port 6, the liquid crystal display is externally controllable. In this manner, display data may be transmitted to the illumination unit by way of the data port 6 such that the presentation on the liquid crystal display 16 is externally controllable. Information may be visualised using the liquid crystal display 16. This can be information relating to the corresponding seat row nearby the illumination unit or may concern corresponding danger situations that may occur during flight. Normal flight information, such as the current speed of the aircraft or the flight altitude, or prohibition information such as “smoking prohibited,” information relating to escape routes, or entertainment for passengers may also be displayed. For example, if a liquid crystal display 16 is provided, the illumination device may display simple information, which may contain an image, slide, pictogram or some text, and may also display moving information, such as changing text or films in addition or alternating with this other information. The display may provide illumination with the option of temporarily displaying information, such as, information relating to a particular seat row. The number of a particular seat row may also be displayed by the illumination unit (for example, the use of the liquid crystal display 16) and that in this way, finding one's seat during boarding is significantly made easier because the number can be displayed at a size that is possible to be easily read from the aisle. Thus, the illumination unit displays clearly visible information that may be changed if desired. After being switched off, these displays may be invisible.

As shown in FIG. 4 three recesses 7, 71, 72 are provided in an aperture 2. Recesses may include optical projection recesses 7, 71 are designed to accommodate an optical projection system (not shown in FIG. 4), which may comprise lenses or lens systems, providing a focusable beam usable by a passenger for reading a book. A diffuser recess 72, accommodate a diffuser, generating diffused light, for example.

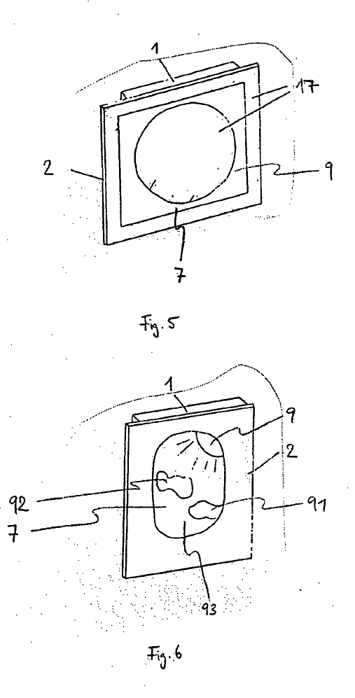

In FIG. 5, a recess 7 in the aperture 2 comprises a transparent material 9, for example plastic, plexiglass or glass. In this embodiment, the transparent material 9 is durable and protects the light source 1, such as from mechanical damage and soiling. The aperture 2 comprises a mirror-like material 17 at least in some regions. In this way, the illumination unit is capable of being used as a lamp in a toilet cabin where installation space may be limited by the size of the cabin. A half-permeable illuminated mirror may be integrated in the side panel of an onboard washroom or toilet.

In FIG. 6. a recess 7 comprises several transparent materials 9, 91, 92, 93 of different colors, which together form a type of “pseudo window”. In this arrangement, the transparent materials 9, 91, 92, 93 represent the sun, clouds and the sky. In this way, cabin windows may be simulated in areas having installations (e.g. risers of the air conditioning system) where it is not possible to provide actual cabin windows.

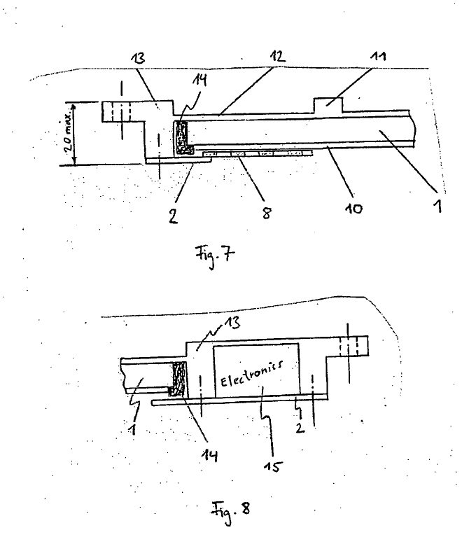

The illumination unit shown in the cross-sectional representation of FIG. 7 comprises a two-dimensional light source 1 and an aperture 2. The aperture 2 comprises a protective mesh 8 which protects the light source 1, especially against mechanical damage for instance. The light source 1 and the aperture 2, are assembled in housing 13. On the rear of the housing 13, is a metal plate 12 may be integrated for cooling the light source 1, which by way of a spacer 11, is kept at a distance with respect to the ceiling paneling to which the illumination unit of FIG. 7 may be attached. A diffuser 10 is provided to generate diffuse light.

FIG. 8 shows a diagrammatic cross-sectional representation of a second region of the illumination device of FIG. 7. The light source 1 has a rubber seal 14, which ensures firm and elastically-held seating of the light source 1 in the housing 13. Furthermore, the housing 13 houses electronics 15 capable of controlling the light source 1 and, optionally, the liquid crystal display 16 (not shown in FIG. 8). The illumination device may be used in the cargo hold of an aircraft, which due to the aircraft structure and fire prevention requirements, needs to be designed to have flat surfaces wherever possible. Other locations include the galley, work areas, cabin, sleeping births and service ducts.

Galley installations may serve as downlights for even illumination of the work surface. Lamps in other work areas may provide light where shallow installation depth is required. Moreover, decorative lamps in the cabin area may provide direct lighting or indirect lighting, e.g. by way of flat suspended ceilings. Such lamps may be used as general lighting in compartments whenever limited installation space is available such as in sleeping berths, in ceiling panels as downlights, or in the service duct as downlights.

An illumination unit may comprise color filters to generate effects in the form of colored filter discs in front of the light source 1. In this arrangement, the effect depends on the chosen wavelength, with the effect being comparable to that of a fluorescent light.

Protective covers made from translucent non-breakable materials may provided, such as non-breakable translucent plastic. To provide protection against glass breakage, a suitable, enveloping shrink foil can be provided so that the illumination unit or parts of the illumination unit are protectively enveloped by a translucent plastic material.

Due to its shallow installation depth, an illumination unit may be installed in housings which are suitable both for flush installation and for installation on a surface.

Implementation of the invention is not limited to the preferred embodiments shown in the figures. Instead, a multitude of variants are possible and will be readily apparent based on the examples described herein.

In addition it should be pointed out that “comprising” does not exclude other elements or steps, and “a” or “one” does not exclude a plural number. Furthermore, it should be pointed out that characteristics or steps which have been described with reference to one of the above embodiments can also be used in combination with other characteristics or steps of other embodiments described above. Reference characters in the claims are not to be interpreted as limitations.

What is claimed:

1. An illumination unit for an aircraft, the illumination unit comprising:
a two-dimensional light source;
an aperture which is at least partially translucent;
an attachment element;
wherein the light source is coupled to the aperture using the attachment element; and
wherein the light source is disposed behind the aperture and is capable of shining through at least a portion of the aperture.

2. The illumination unit of claim 1,
wherein the aperture is an interior fitting element of an aircraft cabin,
the interior fitting element being selected from the group consisting of wall panels, window panels, side panels, ceiling panels and baggage lockers.

3. The illumination unit of claim 1, wherein the light source is a discharge lamp which is free of mercury.

4. The illumination unit of claim 1, wherein the light source comprises an attachment region having an opening, the light source is inserted in the opening and is coupled to the aperture using the attachment element, the attachment element being selected from the group consisting of a screw, a rivet, a self-locking plug-in bolt, and a clip.

5. The illumination unit of claim 1,
wherein the aperture comprises a recess being at least partially filled with a transparent material that is durable.

6. The illumination unit of claim 5, wherein the transparent material is selected from the group consisting of plastic, plexiglass, and glass.

7. The illumination unit of claim 1, wherein the aperture comprises a protective mesh or a protective cover to protect the light source against mechanical damage.

8. The illumination unit of claim 5, wherein the recess is designed to accommodate a diffuser, a radiation filter or projection optics having at least one lens.

9. The illumination unit of claim 1, wherein the aperture comprises a recess, and the recess is designed to accommodate a liquid crystal display.

10. The illumination unit of claim 9, further comprising a data port for externally controlling the liquid crystal display, such that
display data is transmitted to the illuminating unit and the liquid crystal display is controllable.

11. The illumination unit of claim 9, wherein the liquid crystal display is capable of providing information selected from the group consisting of static information, dynamic information, seat-row information, seat place information, warning information, prohibition information, flight information, escape route information and entertainment information, through the liquid crystal display.

12. An aircraft comprising an illumination unit of claim 1.
